(19) United States
(12) Patent Application Publication
(10) Pub. No.: US 2018/0086359 A1
(43) Pub. Date: Mar. 29, 2018

(54) STROLLER TRAY OR BUMPER BAR WITH MOVEMENT IN TWO AXES

(71) Applicant: Helen of Troy Limited, Belleville (BB)

(72) Inventors: Thomas C. Hanson, New York, NY (US); Troy H. Phipps, Brooklyn, NY (US)

(21) Appl. No.: 15/676,319

(22) Filed: Aug. 14, 2017

Related U.S. Application Data
(60) Provisional application No. 62/400,108, filed on Sep. 27, 2016.

(51) Int. Cl. B62B 9/24; B62B 9/26

(52) U.S. Cl. CPC B62B 9/245; B62B 9/26

(57) ABSTRACT

A bumper bar assembly for a stroller includes a first end bar member, a second end bar member, and an intermediate member connected with and disposed between the first end bar member and the second end bar member. The first end bar member is configured to connect with a stroller frame at or adjacent to a first side of the stroller frame. The second end bar member is configured to connect with the stroller frame at or adjacent to a second side, which is opposite to the first side, of the stroller frame. The intermediate member is pivotable with respect to at least of the first bar member and the second bar member about at least two axes.

### BACKGROUND

Strollers are often equipped with a tray or bumper bar positioned in front of a seat back and above a seat bottom of a child seat. Some known strollers include the tray or bumper bar mounted to a stroller frame so that the tray or bumper bar can be pivoted or slid away from the child seat to facilitate removal of the child from or placement of the child into the seat. These known strollers, however, are limited as to the manner in which the tray or bumper bar is movable with respect to the stroller frame.

### SUMMARY

In view of the foregoing, a bumper bar assembly for a stroller includes a first end bar member, a second end bar member, and an intermediate member connected with and disposed between the first end bar member and the second end bar member. The first end bar member is configured to connect with a stroller frame at or adjacent to a first side of the stroller frame. The second end bar member is configured to connect with the stroller frame at or adjacent to a second side, which is opposite to the first side, of the stroller frame. The intermediate member is pivotable with respect to at least one of the first bar member and the second bar member about at least two axes.

The intermediate member discussed above can be an intermediate bar member connected at each end with the first end bar member and the second end bar member, respectively. A tray can connect with at least one of the first end bar member, the second end bar member and the intermediate bar member. The intermediate member could also simply be a tray connected with the first end bar member and the second end bar member.

In view of the foregoing, a stroller includes a stroller frame, a seat supported by the stroller frame, and a bumper bar assembly selectively connected with a stroller frame. The bumper bar assembly includes a first end bar member, a second end bar member, and an intermediate member. The first end bar member connects with the stroller frame at or adjacent to a first side of the stroller frame. The second end bar member connects with the stroller frame at or adjacent to a second, opposite, side of the stroller frame. The intermediate member connects with the first end bar member and the second end bar member. The second end bar member and the intermediate member are pivotable together with respect to the first end bar member about at least two intersecting axes when the second end bar member is disconnected from the stroller frame.

### BRIEF DESCRIPTION OF THE DRAWINGS

FIG. 1 is a front perspective view of a stroller frame in a deployed position.

FIG. 2 is a perspective view of an example of a bumper bar assembly.

FIG. 3 is a perspective view of the bumper bar assembly in FIG. 2 with a tray removed from an intermediate bar member.

FIG. 4 depicts the bumper bar assembly shown in FIG. 2 in which a first end bar member and an intermediate member are pivoted together with respect to a second end bar member from the orientation shown in FIG. 2 about a first axis.

FIG. 5 depicts the bumper bar assembly shown in FIG. 2 in which the first end bar member and the intermediate member are pivoted together with respect to the second end bar member from the orientation shown in FIG. 2 about a second axis, which is transverse to the first axis.

FIG. 6 is a schematic cross sectional view taken along line 6-6 in FIG. 2.

### DETAILED DESCRIPTION

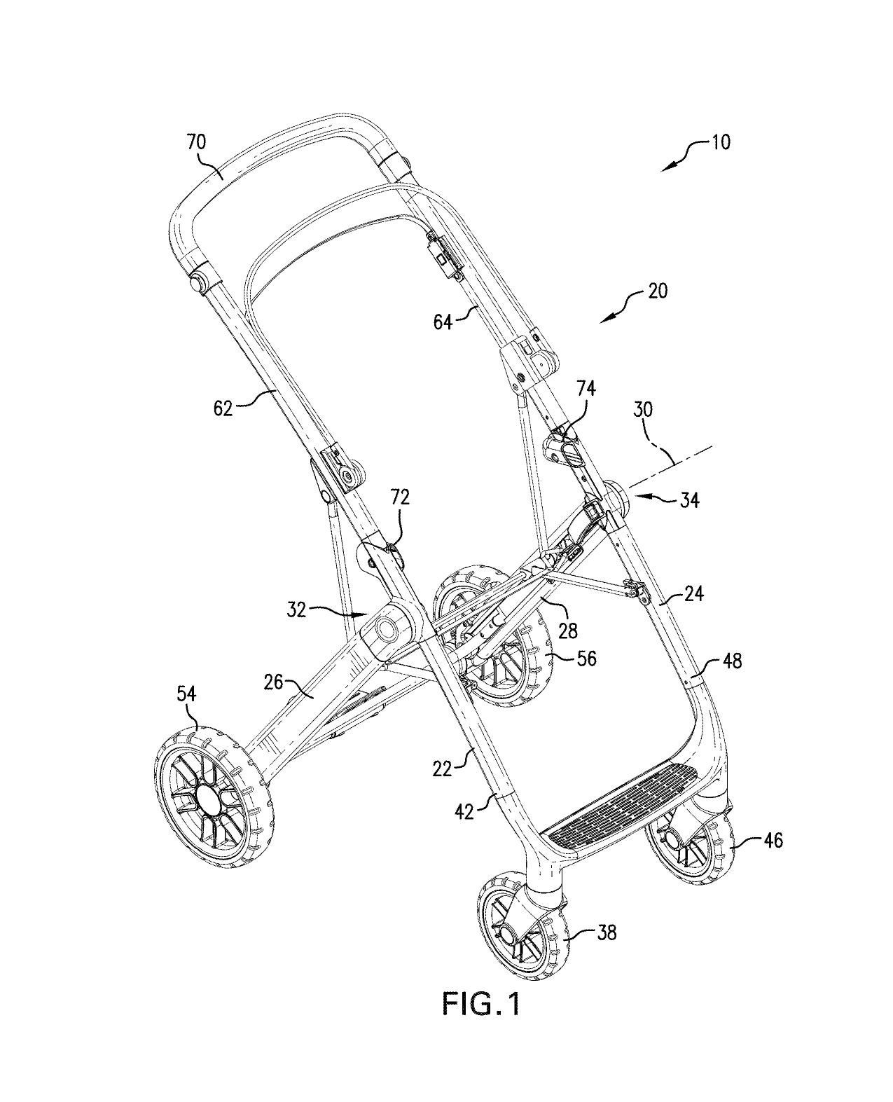

With reference to FIG. 1, a stroller 10 includes soft goods (not shown in FIG. 1) that can include a seat (not shown), a canopy (not shown) and a basket (not shown). The stroller 10 further includes a stroller frame 20 that supports the soft goods. The soft goods can vary considerably in configuration and are not shown in detail to provide more clarity to the drawings. The stroller frame 20 (as well as the stroller 10) is moveable between a deployed position, which is shown in FIG. 1, and a collapsed position. The stroller frame 20 includes a front right leg 22, a front left leg 24, a rear right leg 26 and a rear left leg 28. The front legs 22, 24 can pivot with respect to the rear legs 26, 28 about a leg collapse axis 30. The front right leg 22 connects with the rear right leg 26 at a right hinge mechanism 32. The front left leg 24 and the rear left leg 28 connect at a left hinge mechanism 34. The hinge mechanisms 32, 34 on the stroller frame 20 allow for movement of the stroller frame 20 between the collapsed position and the deployed position.

A front right wheel 38 connects to the stroller frame 20 adjacent a lower end 42 of the front right leg 22. Similarly, a front left wheel 46 connects to the stroller frame 20 adjacent a lower end 48 of the front left leg 24. A rear right wheel 54 connects with the rear right leg 26 at an end opposite the right hinge mechanism 32. A rear left wheel 56 connects with the rear left leg 28 at an end opposite the left hinge mechanism 34. A right handle support member 62 connects with the front right leg 22 and a left handle support member 64 connects with the front left leg 24. A handle 70, which is used to maneuver the stroller 10, connects with the handle support members 62, 64. A right bumper bar connector 72 connects with the front right leg 22 and a left bumper bar connector 74 connects with the front left leg 24.

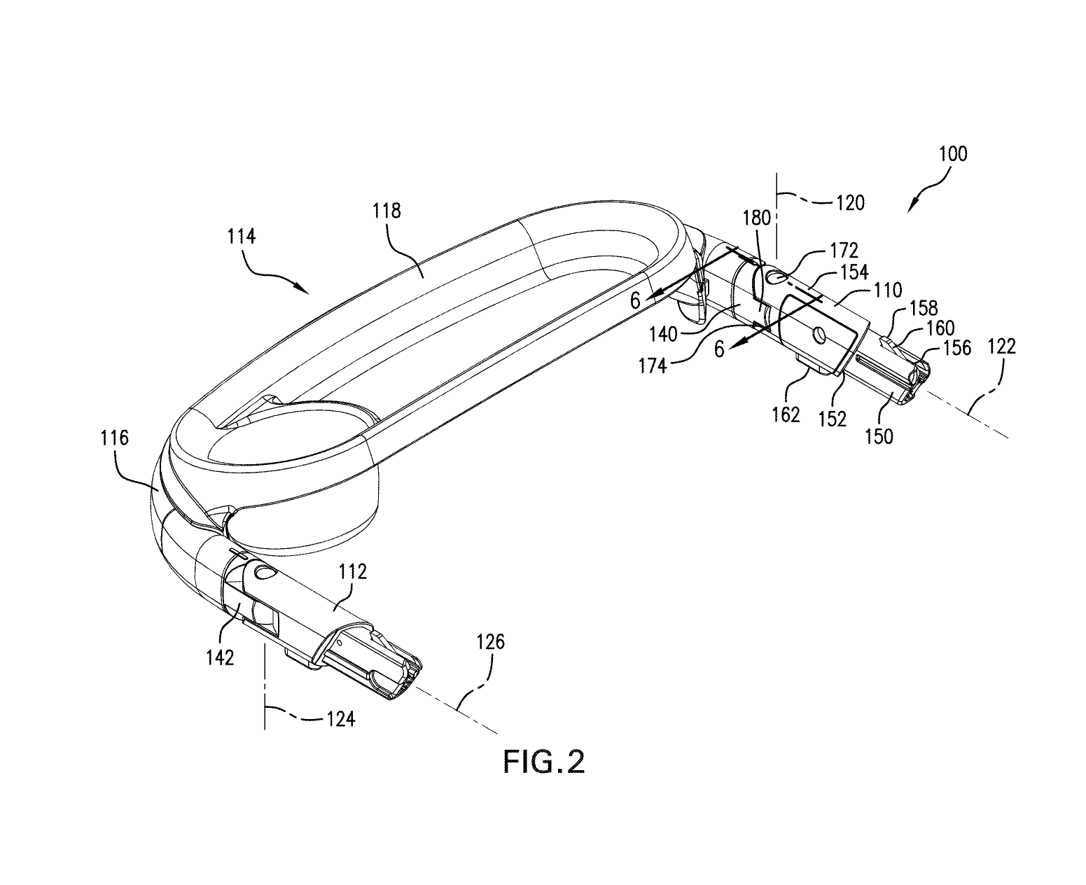

The stroller 10 that has been described above is only one example of such a stroller 10 that can be used with a bumper bar assembly 100 depicted in FIG. 2. The bumper bar assembly 100 shown in FIG. 2 mounts to the stroller frame 20 in front of a seat back and above a seat bottom of a seat (not shown) similar to known trays or bumper bars. The bumper bar assembly 100, however, differs from known bumper bars and trays in how the bumper bar assembly 100 moves with respect to the stroller frame 20.

FIG. 2 depicts the bumper bar assembly 100 as including a first end bar member 110, a second end bar member 112, and an intermediate member 114 connected with and disposed between the first end bar member 110 and the second end bar member 112. The first end bar member 110 is configured to connect with the stroller frame 20 depicted in FIG. 1 at or adjacent to a first (right) side of the stroller frame 20. As such, the first end bar member 110 may be referred to as the right end bar member. For ease of understanding the figures, however, this and other directional terms, e.g., right, left, horizontal, vertical, should not be used to limit the scope of the appended claims. The second end bar member 112 is configured to connect with the stroller frame 20 at or adjacent to a second (left) side, which is opposite to the first side, of the stroller frame 20. As such, the second end bar member 112 can also be referred to as the left end bar member.

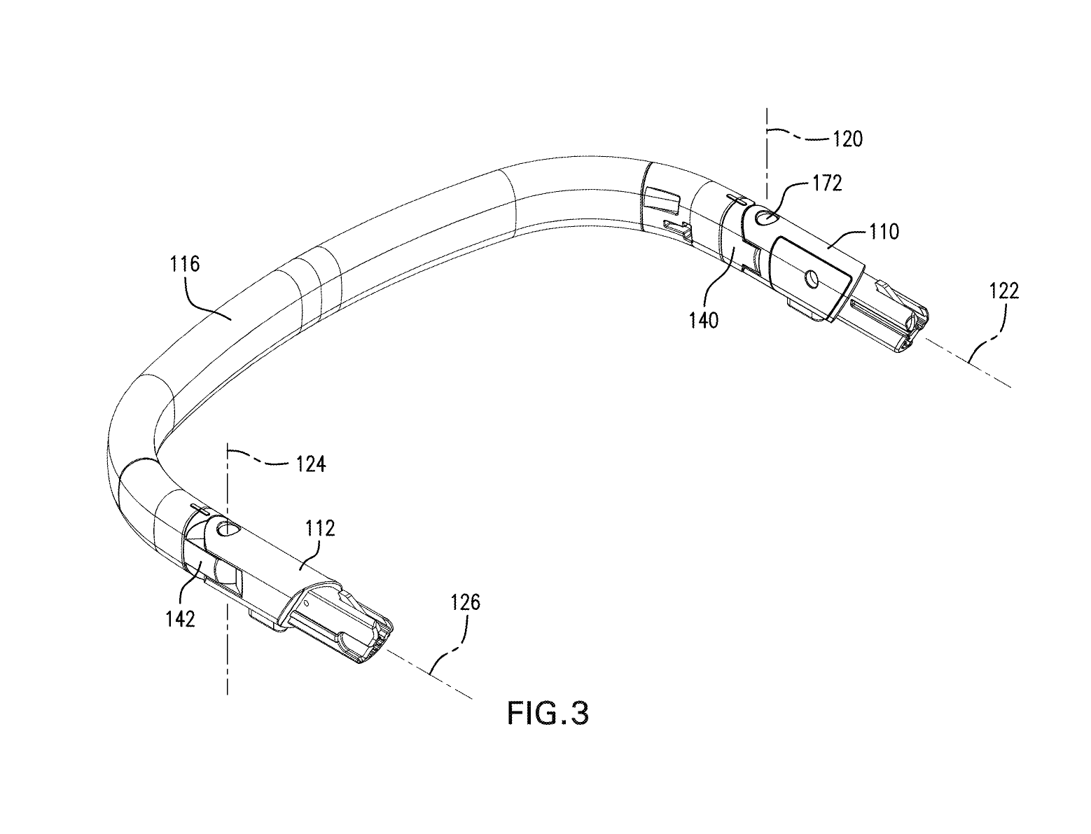

The intermediate member 114 connects with and is disposed between the first end bar member 110 and the second end bar member 112. The intermediate member 114 can be an intermediate bar member 116 connected with the first end bar member 110 and the second end bar member 112. The intermediate member 114 may also be a tray 118 connected with the first end bar member 110 and the second end bar member 112. The tray 118 depicted in FIG. 2 is removably connected with the intermediate bar member 116 (see FIG. 3); however, the tray 118 could connect with the first end bar member 110 and the second end bar member 112 in a manner similar to the manner in which the intermediate bar member 116 is connected with the first end bar member 110 and the second end bar member 112. In addition, the tray 118 and the intermediate bar member 116 could be made as a unit so as to travel and move with respect to the first end bar member 110 and the second end bar member 112 in the same manner as described above in which the intermediate bar member 116 moves with respect to the first end bar member 110 and the second end bar member 112. The intermediate member 114 is pivotable with respect to at least one of the first end bar member 110 and the second end bar member 112 about at least two axes, e.g., a first (vertical) right axis 120 and a second (horizontal) right axis 122, which intersect one another in the illustrated embodiment. In an alternative arrangement, the first (vertical) right axis 120 and a second (horizontal) right axis 122 could be offset from each other so as not to intersect one another, for example if either the first end bar member 110 or the second end bar member 112 was located above or below the intermediate member 114.

In the bumper bar assembly 100 as illustrated, the intermediate member 114 is pivotable with respect to both the first end bar member 110 and the second end bar member 112 about at least two axes, respectively. With reference to FIG. 3, the intermediate bar member 116 and the second end bar member 112 can pivot with respect to the first end bar member 110 about the first (vertical) right axis 120 when the second end bar member 112 is disconnected from the stroller frame 20 (FIG. 1). Also, the intermediate bar member 116 and the second end bar member 112 are also pivotable together with respect to the first end bar member 110 about the second (horizontal) right axis 122 when the second end bar member 112 is disconnected from the stroller frame 20 (FIG. 1). The intermediate bar member 116 and the first end bar member 110 can pivot with respect to the second end bar member 112 about a first (vertical) left axis 124 when the first end bar member 110 is disconnected from the stroller frame 20 (FIG. 1). Also, the intermediate bar member 116 and the first end bar member 110 are also pivotable together with respect to the second end bar member 112 about a second (horizontal) left axis 126 when the first end bar member 110 is disconnected from the stroller frame 20 (FIG. 1).

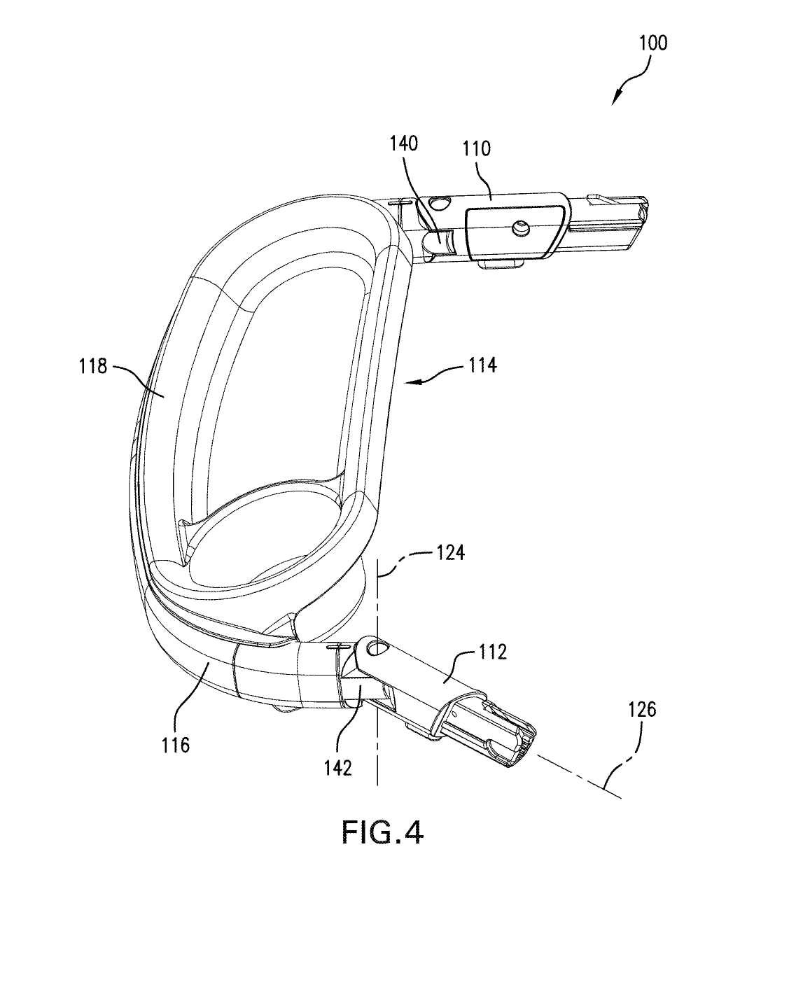

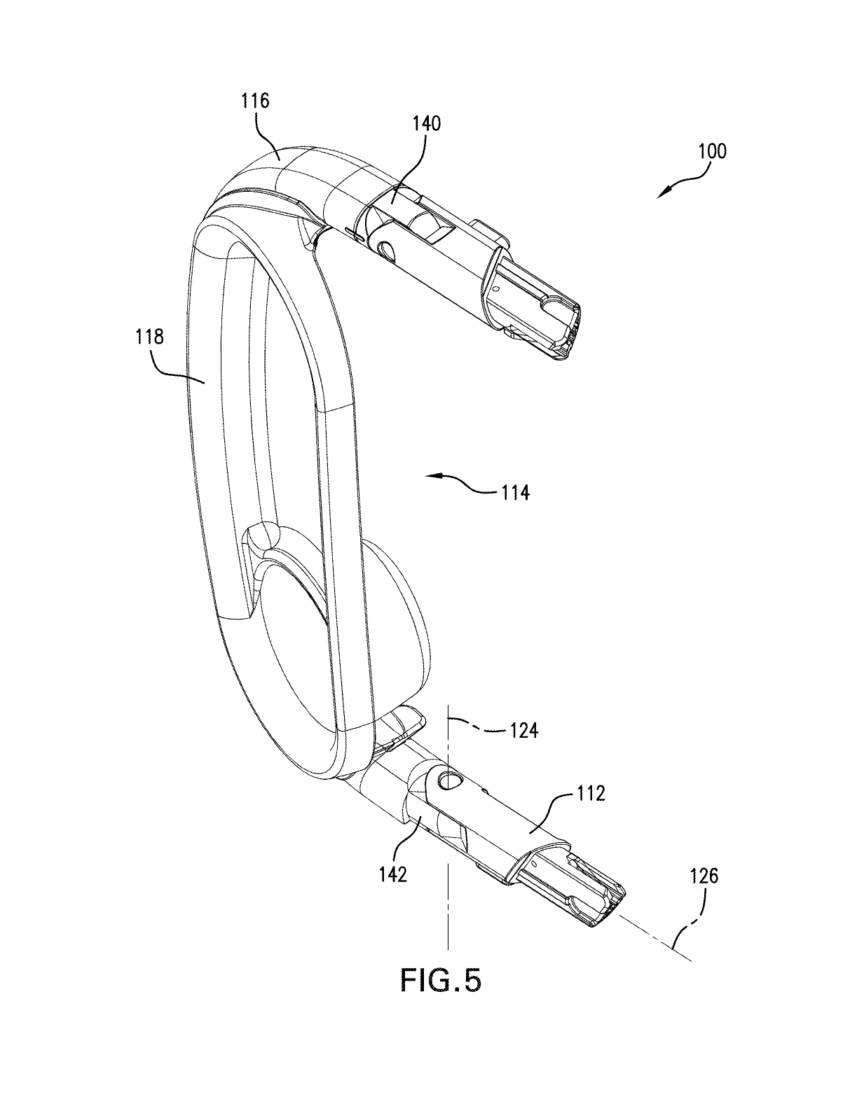

Even though the tray 118 is not depicted in FIG. 3, when the tray 118 is connected with the intermediate bar member 116 the tray 118 moves along with the intermediate bar member 116. FIGS. 4 and 5 show movement of the intermediate bar member 116, the tray 118 and the first end bar member 110 with respect to the second end bar member 112 about the first (vertical) left axis 124 and movement of the intermediate bar member 116, the tray 118 and the first end bar member 110 with respect to the second (horizontal) left axis 126. The intermediate bar member 116 and the second end bar member 112 can move with respect to the first end bar member 110 in the same manner. In the illustrated bumper bar assembly 100, each first axis 120, 124 is perpendicular with the respective second axis 122, 126. Each first axis 120, 124 is generally vertically oriented when the bumper bar assembly 100 is connected with the stroller frame 20 and the stroller frame 20 is in a deployed configuration, which is shown in FIG. 1. Each second axis 122, 126 is generally horizontally oriented when the when the bumper bar assembly 100 is connected with the stroller frame 20 and the stroller frame 20 is in the deployed configuration, which is shown in FIG. 1.

To facilitate movement about the aforementioned axes 120, 122, 124 and 126, the bumper bar assembly 100 can be provided with a first (right) hinge connector element 140 connected with and positioned between the first end bar member 110 and the intermediate member 114 and a second (left) hinge connector element 142 connected with and positioned between the second end bar member 112 and the intermediate member 114. The first hinge connector element 140 is rotatable with respect to the first end bar member 110 about the first (vertical) right axis 120. Similarly, the second hinge connector element 142 is rotatable with respect to the second end bar member 112 about the first (vertical) left axis 124. The intermediate member 114 (FIG. 2) is rotatable with respect to the first hinge connector element 140 about the second (horizontal) right axis 122. The intermediate member 114 is also rotatable with respect to the second hinge connector element 142 about the second (horizontal) left axis 126. The intermediate member 114 cooperates with the first hinge connector element 140 such that the intermediate member 114 is rotatable about the second (horizontal) right axis 122 and movable into a plurality of different fixed positions in which the intermediate member 114 is precluded from moving with respect to the first hinge connector element 140 until acted upon by a force other than gravity. Likewise, and as shown in FIG. 5, the intermediate member 114, which is made up of the intermediate bar member 116 and the tray 118 in the illustrated embodiment, cooperates with the second hinge connector element 142 such that the intermediate member 114 is rotatable about the second (horizontal) left axis 126 and moveable into a plurality of different fixed positions in which the intermediate member 114 is precluded from moving with respect to the second hinge connector element 142 until acted upon by a force other than gravity. In other words, the tray 118 and the intermediate bar member 116 can be rotated about either first (vertical) axis 120 or 124 when the appropriate end bar member 110 or 112 is disconnected from the stroller frame 20. Also, the intermediate bar member 116 and the tray 118 can be rotated, upwards or downwards, about either second (horizontal) axis 122 or 126 when the appropriate end bar member 110 or 112 is disconnected from the stroller frame 20. The connection between the intermediate member 114 (and more specifically in the illustrated embodiment the intermediate bar member 116) and the respective hinge connector elements 140, 142 is such that the intermediate member 114 with the appropriate end bar member 110 or 112 attached thereto can maintain the position in which it is placed, such as that shown in FIG. 5, until acted upon by a force other than gravity. This facilitates easier removal of the child from or placement of the child into the seat of the stroller 10 because the tray 118 or the intermediate bar member 116 can be moved out of the way and retain the position in which it was moved about either horizontal axis 122 or 126.

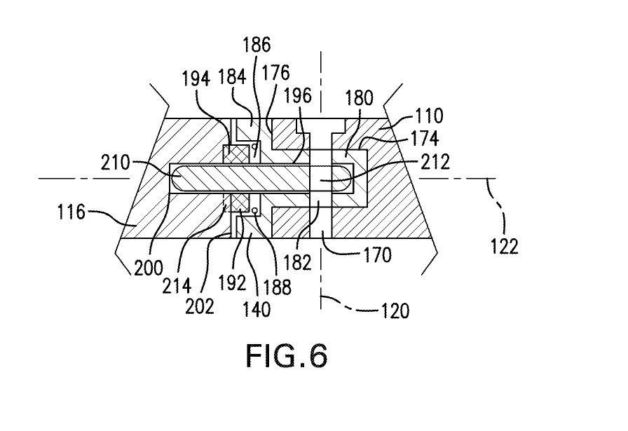

FIG. 6 is a schematic cross-sectional view taken through a portion of the first end bar member 110, the first hinge connector element 140, and the intermediate bar member 116. FIG. 6 is a schematic depiction depicting how the first end bar member 110 connects with the intermediate bar member 116 using the first hinge connector element 140. The second end bar member 112 connects with the intermediate bar member 116 through the second hinge connector element 142 in a similar manner. As such, the connection between the first end bar member 110, the first hinge connector element 140 and the intermediate bar member 116 will be described in detail with the understanding that the connection between the second end bar member 112, the second hinge connector element 142, and the intermediate bar member 116 is similar.

With reference back to FIG. 2, the first end bar member 110 includes a stroller connector portion 150, a shoulder 152, and a hinge connector portion 154. The stroller connector portion 150 operates as a type of male connector that allows the stroller connector portion 150 to be inserted into the right bumper bar connector 72 (FIG. 1) on the stroller frame 20 to connect the bumper bar assembly 100 with the stroller frame 20. The stroller connector portion 150 can be inserted into the right bumper bar connector 72 until the shoulder 152 contacts the right bumper bar connector 72. The stroller connector portion 150 includes a slot 156 through which a latch member 158 extends. The latch member 158 is biased so that it extends upwardly through the slot 156 per the orientation shown in FIG. 2. A button 162 is operatively connected with the latch member 158. Pressing upwardly (per the orientation shown in FIG. 2) on the button 162 results in the latch member 158 moving downwardly into the stroller connector portion 150 to allow for removal of the stroller connector portion 150 from the right bumper bar connector 72. The latch member 158 has a sloped leading surface 160 which allows the latch member 158 to move into the slot 156 while the stroller connector portion 150 is being inserted into the right bumper bar connector 72 until the latch member 158 engages in appropriate recess in the right bumper bar connector 72 to allow the bumper bar assembly 100 to connect with the stroller frame 20.

The second end bar member 112 connects with the left bumper bar connector 74 in a similar manner as the first end bar member 110 connects with the right bumper bar connector 72. The end bar members 110, 112 can connect with the stroller frame 20 in other conventional manners.

With reference back to FIG. 6, the first end bar member 110 includes a pin passage 170 that is coaxial with the first (vertical) right axis 120. The pin passage 170 receives a pin 172 (FIG. 2) for connecting the first end bar member 110 with the first hinge connector element 140. The first end bar member 110 also includes a slot 174. The slot 174 extends forwardly from a rear face 176 of the first end bar member 110. The rear face 176 is adjacent the first hinge connector element 140.

The first hinge connector element 140 includes a forward section 180 that is received in the slot 174 provided in the first end bar member 110. The forward section 180 acts as a male connector received in the slot 174. The first hinge connector element 140 also includes a pin passage 182 aligned with the pin passage 170 in the first end bar member 110. The pin 172 (FIG. 2) also extends through the pin passage 182 to connect the first hinge connector element 140 with the first end bar member 110. The first hinge connector element 140 also includes a rear section 184. A recess 186 can be provided in the first hinge connector element 140 formed in the rear section 184. The recess 186 can receive a biasing member 188, such as a compression spring, and a toothed disk 192 having a plurality of teeth 194, which extends towards the intermediate bar member 116. The first hinge connector element 140 also includes an axle bore 196 that is coaxial with the second (horizontal) right axis 122.

The intermediate bar member 116 includes a bore 200 which extends rearwardly from a rear face 202 of the intermediate bar member 116. The bore 200 is aligned with the second (horizontal) right axis 122. An axle 210 is received in the bore 200 and extends through the axle bore 196 provided in the first hinge connector element 140. The axle 210 includes a pin opening 212, which receives the pin 172 (FIG. 2).

The intermediate bar member 116 connects with the axle 210 so that the intermediate bar member 116 can rotate with respect to the axle 210, which cannot rotate because of the connection with the pin 172. The intermediate bar member 116 also includes a plurality of teeth 214 that cooperate with the teeth 194 of the toothed disk 192. Rotation of the intermediate bar member 116 (and the tray 118 if attached thereto) and the second end bar member 112 about the second (horizontal) right axis 122 results in the teeth 214 riding over the teeth 194. The biasing member 188 biases the toothed disk 192 toward the teeth 214 formed in the rear face 202 of the intermediate bar member 116. When an operator rotates the intermediate bar member 116 about the second (horizontal) right axis 122, the biasing force of the biasing member 188 is overcome so that the teeth 194 on the toothed disk 192 ride over the teeth 214 on the intermediate bar member 116. When the operator has moved the intermediate bar member 116 to the desired position, the biasing member 188 provides enough force such that the second end bar member 112 and the intermediate bar member 116 with the tray 118 attached thereto is precluded from moving with respect to the first end bar member 110 until acted upon by a force other than gravity. This allows the tray 118 to remain vertically oriented (if desired) to facilitate removal of the child from or placement of the child into the seat of the stroller 10. The intermediate bar member 116 and the tray 118 attached thereto can be moved in two different axes to provide ample room for removing the child from or placing the child into the stroller 10.

In an alternative arrangement, the toothed disk 192 could be replaced with a disk having a friction face, which has a high friction surface that is relatively flat and replaces the teeth 194 on the toothed disk. The teeth 214 on the intermediate bar member 116 could then be replaced by a similar friction face facing the friction face of the disk. This alternative arrangement would operate similarly to the toothed disk arrangement, however, it would be infinitely adjustable in comparison to teeth arrangement that have a set number of angles based on the number of teeth provided. The friction face of the disk would be biased toward the friction face on the intermediate bar member 116 and the biasing member 188 would provide enough force such that the second end bar member 112 and the intermediate bar member 116 with the tray 118 attached thereto is precluded from moving with respect to the first end bar member 110 until acted upon by a force other than gravity.

A stroller bumper bar assembly and a stroller having such a bumper bar assembly has been described above in detail. Modifications and alterations will occur to those upon reading and understanding the preceding detailed description. The invention, however, is not limited to only the embodiments described above, instead, the invention is broadly defined by the appended claims and the equivalents thereof.

1. A bumper bar assembly for a stroller, comprising:
a first end bar member configured to connect with a stroller frame at or adjacent a first side of the stroller frame;
a second end bar member configured to connect with the stroller frame at or adjacent a second side, which is opposite to the first side, of the stroller frame;
an intermediate member connected with and disposed between the first end bar member and the second end bar member, the intermediate member being pivotable with respect to at least one of the first end bar member and the second end bar member about at least two axes.

2. The bumper bar assembly of claim 1, wherein the at least two axes include a first axis and a second axis, which is perpendicular to the first axis.

3. The bumper bar assembly of claim 1, further comprising a first hinge connector element connected with and positioned between the first end bar member and the intermediate member.

4. The bumper bar assembly of claim 3, wherein the first hinge connector element is rotatable with respect to the first end bar member about a first axis of the at least two axes.

5. The bumper bar assembly of claim 4, wherein the first axis is vertically oriented when the bumper bar assembly is connected with the stroller frame and the stroller frame is in a deployed configuration.

6. The bumper bar assembly of claim 3, wherein the intermediate member is rotatable with respect to the first hinge connector element about a second axis of the at least two axes.

7. The bumper bar assembly of claim 6, wherein the second axis is horizontally oriented when the bumper bar assembly is connected with the stroller frame and the stroller frame is in a deployed configuration.

8. The bumper bar assembly of claim 7, wherein the intermediate member cooperates with the first hinge connector element such that the intermediate member is rotatable about the second axis and movable into a plurality of different fixed positions in which the intermediate member is precluded from moving with respect to the first hinge connector element until acted upon by a force other than gravity.

9. The bumper bar assembly of claim 6, wherein the intermediate member cooperates with the first hinge connector element such that the intermediate member is rotatable about the second axis and movable into a plurality of different fixed positions in which the intermediate member is precluded from moving with respect to the first hinge connector element until acted upon by a force other than gravity.

10. The bumper bar assembly of claim 1, wherein the intermediate member is an intermediate bar member, and further comprising a tray connected with at least one of the first end bar member, the second end bar member and the intermediate bar member.

11. The bumper bar assembly of claim 10, wherein the tray is connected with the intermediate bar member and pivotable with respect to at least one of the first end bar member and the second end bar member about the at least two axes.

12. The bumper bar assembly of claim 11, wherein the at least two axes includes a first axis and a second axis, wherein the tray and the intermediate bar member are rotatable about the second axis and movable into a plurality of different fixed positions in which the intermediate bar member with the tray connected thereto is precluded from moving with respect to the first end bar member until acted upon by a force other than gravity.

13. The bumper bar assembly of claim 1, wherein the intermediate member includes an intermediate bar member pivotable with respect to both the first end bar member and the second end bar member about at least two axes, respectively.

14. The bumper bar assembly of claim 1, wherein the intermediate member includes a tray pivotable with respect to both the first end bar member and the second end bar member about at least two axes, respectively.

15. The bumper bar assembly of claim 1, wherein the at least two axes include a first axis and a second axis, which intersect each other.

16. A stroller comprising:
a stroller frame; and
the bumper bar assembly of claim 1 connected with the stroller frame.

17. A stroller comprising:
a stroller frame;
a seat supported by the stroller frame;
a bumper bar assembly selectively connectable with the stroller frame, the bumper bar assembly including a first end bar member connectable with the stroller frame at or adjacent a first side of the stroller frame, a second end bar member connectable with the stroller frame at or adjacent a second, opposite, side of the stroller frame, and an intermediate member connected with the first end bar member and the second end bar member, the second end bar member and the intermediate member being pivotable together with respect to the first end bar member about at least two axes when the second end bar member is disconnected from the stroller frame.

18. The stroller of claim 17, wherein the at least two axes includes a first axis and a second axis, wherein the second end bar member and the intermediate member are rotatable about the second axis and movable into a plurality of different fixed positions in which the second end bar member and the intermediate member are precluded from moving with respect to the first end bar member until acted upon by a force other than gravity.

19. The stroller of claim 18, wherein the intermediate member includes an intermediate bar member and a tray connected with the intermediate bar member, wherein the tray and the intermediate bar member are rotatable about the second axis and movable into a plurality of different fixed positions in which the intermediate bar member with the tray connected thereto is precluded from moving with respect to the first end bar member until acted upon by a force other than gravity.

20. The stroller of claim 17, wherein the at least two axes includes a first axis and a second axis, which are perpendicular to each other.
